(19) United States
(12) Patent Application Publication
(10) Pub. No.: US 2006/0011368 A1
(43) Pub. Date: Jan. 19, 2006

(54) Transfer center

(76) Inventors: Hiroyuki Maruyama, Irvine, CA (US); John Spencer, Costa Mesa, CA (US); Clas Siversten, Lilburn, GA (US); Tohru Iwama, Irvine, CA (US)

Correspondence Address: GREENBERG TRAURIG LLP, 2450 COLORADO AVENUE, SUITE 400E, SANTA MONICA, CA, 90404, US

(21) Appl. No.: 11/177,168

(22) Filed: Jul. 7, 2005

Related U.S. Application Data
(63) Continuation-in-part of application No. 10/848,104, filed on May 17, 2004.
(60) Provisional application No. 60/554,797, filed on Mar. 19, 2004.

(51) Int. Cl. H01B 11/02

(52) U.S. Cl. 174/33; 174/113 R

(57) ABSTRACT

A system and method of interfacing data between a first electronic device and a second electronic device is disclosed. In one embodiment, the first and second electronic devices are cell phones manufactured by different manufacturers. The first electronic device can be the source device, and the second electronic device can be the target device. A data transfer hub having universal connectors is coupled with at least one of a plurality of adapter cables. The first and second electronic devices are connected to the data transfer hub using at least one of the plurality of adapter cables. The data transfer hub is connected to the computer system, wherein the computer system is configured to receive and transmit data from the first electronic device and the second electronic device. The data is then transmitted from the first electronic device to the second electronic device.

### RELATED APPLICATION

This application is continuation-in-part of U.S. application Ser. No. 10/848,104, filed May 17, 2004, which claims the benefit of the prior filing date of U.S. provisional patent application No. 60/554,797, filed Mar. 19, 2004, herein incorporated by reference in its entirety.

### BACKGROUND OF THE DISCLOSURE

1. Field of the Disclosure

The transfer center is directed to a data transfer hub that permits interfacing data between a first electronic device and a second electronic device having different interface connectors and electronic signaling requirements. In particular, the data transfer hub interfaces data between a first cellular phone and a second cellular phone.

2. General Background

Cellular phones are able to recharge their batteries and exchange data through an interface connector provided with the cellular phones. Each cellular phone manufacturer, however, may utilize different interface connectors, and therefore the interface connector may be different from one manufacturer to another. That is, there is no standard with regard to the configuration of the interface connectors to interface data between the cellular phone and other electronic devices such as personal computers (computer systems) and Personal Digital Assistants (PDAs).

As such, to interface information between a particular cellular phone and a computer system or between cellular phone a user needs to have a specific cable with a particular connector that is designed for that particular cellular phone to interface the information.

Furthermore, when it comes to backing up data of a cell phone, or update data, upload data to a cell phone, current systems lack uniformity since current systems tailor, if at all, to one manufacturer. Most importantly, transferring data from one cell phone to a second cell phone is very difficult because each manufacturer has different data transmission and storage standards.

### SUMMARY

In one aspect there is a method of interfacing data between a first electronic device and a second electronic device. In one embodiment, the first and second electronic devices are cell phones manufactured by different manufacturers. The first electronic device can be the source device, and the second electronic device can be the target device. A data transfer hub having universal connectors is coupled with at least one of a plurality of adapter cables. The first and second electronic devices are connected to the data transfer hub using at least one of the plurality of adapter cables. The data transfer hub is connected to the computer system, wherein the computer system is configured to receive and transmit data from the first electronic device and the second electronic device. The data is then transmitted from the first electronic device to the second electronic device.

The first electronic device and the second electronic device can be cell phones, personal data assistants, etc. In another aspect, the first electronic device is manufactured by a different manufacturer than the second electronic device.

Furthermore, the computer system can be configured to convert data from the first electronic device into a data format that can be recognized by the second electronic device. The computer system can also include a computer application that is configured to convert data from the data from the first electronic device into a data format that can be recognized by the second electronic device. The data transfer hub and the computer system can be connected via a universal serial bus connection.

In another aspect, there is a method of interfacing data between a computer system and a plurality of portable wireless devices. A data transfer hub and a plurality of adapter cables are provided, wherein the a data transfer hub has a computer system connector and at least one universal port, and wherein each of the plurality of adapter cables has an adapter connector end and an adapter interface end. The data transfer hub is configured to communicably couple with a computer system. The adapter connector end of each of the plurality of the adapter cables is configured to communicably couple with a corresponding data communication connector provided in the plurality of portable devices. The adapter interface end of each of the plurality of the adapter cables is configured to communicably couple with the at least one universal port of the data transfer hub to allow the computer system to communicate with any one of the plurality of portable devices. The plurality of the portable devices can be wireless devices manufactured by different manufacturers.

The computer system device can be configured to recognize the communication signals of each of the plurality of portable devices based on the adapter cable portion being used.

The adapter cables can be marked with a different symbol to associate each of the plurality of adapter cables with the corresponding data communication connector provided in the plurality of portable devices.

In another aspect, there is a system to interface data between a computer system and a plurality of cell phones. The system includes a data transfer hub having a computer system connector and at least one universal port. The system can also include a plurality of adapter cables, wherein each of the plurality of adapter cables has an adapter connector end and an adapter interface end. The system can further include a computer system communicably coupled to the data transfer hub. The adapter connector end of each of the plurality of the adapter cables can be configured to communicably couple with a corresponding data communication connector provided in the plurality of portable devices. The adapter interface end of each of the plurality of the adapter cables can be configured to communicably couple with the at least one universal port of the data transfer hub to allow the computer system to communicate with any one of the plurality of portable devices.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 illustrates a cable system including a base cable and a plurality of adapter cables configured to interface data between a personal computer and a plurality of cellular phones.

FIG. 2 illustrates each of the adapter cables including a symbol on the adapter interface end, each of the symbols corresponding to a particular cellular phone.

FIG. 3 illustrates a cable system including a base cable adapted to communicably couple with an infrared attachment.

FIG. 4 illustrates a cable system including a base cable and an alternative plurality of adapters.

FIG. 5 illustrates a cable system including an alternative base cable and a plurality of adapter cables.

FIG. 6 illustrates a cable system including an intermediate cable between a base cable and a plurality of adapters to interface data between a personal computer and a plurality of cellular phones.

FIG. 7A illustrates a data transfer hub and a converter to interface data between a personal computer and a plurality of cellular phones.

FIG. 7B illustrates a data transfer hub and two converters that allow two cell phones to interface with a personal computer.

FIG. 8 illustrates a cable system adaptable to a transfer center to transfer data from a first cellular phone to a second cellular phone.

FIG. 9A illustrates an external view of a data transfer hub.

FIG. 9B illustrates a component diagram of a data transfer hub.

FIG. 10 illustrates the data transfer hub connectivity to a computer system and to at least two cellular phones.

FIG. 11 illustrates a screenshot of a computer interface application showing the data transfer operation.

### DETAILED DESCRIPTION

The transfer center is directed to a data transfer hub that permits interfacing data between a first electronic device and a second electronic device having different interface connectors and electronic signaling requirements.

The data transfer hub and cable system can be used in a variety of applications. For instance, the data transfer hub and cable system may be used to interface data between a computer system and a plurality of cellular phones. The plurality of cellular phones may be manufactured by different manufacturers, and each manufacturer may use a different interface connector. The cable system can include a base cable and a plurality of adapter cables. Each of the adapter cables is configured to communicably couple with one of the plurality of cellular phones. Depending on the cellular phone a user is using, the user may select one adapter cable, from the plurality of adapter cables, which is configured to communicably couple with the user's cellular phone. The base cable has a base connector and a base interface end. The base connector of the base cable is adapted to communicably couple to a first electronic device such as a computer system. Each of the plurality of adapter cables has an adapter connector and an adapter interface end. The base interface end of the base cable is configured to communicably couple with the adapter interface end of the selected adapter cable, along with adapter interface ends of other adapter cables.

In another embodiment, the data transfer hub includes the functionality of the base cable and allows a plurality of cell phones to communicably couple a computer system. Thus, the data transfer hub can be communicably coupled with the computer system while the adapter connector of the selected adapter cable is communicably coupled to the user's cellular phone. With the communication line linked from the computer system to the data transfer hub, from the data transfer hub to the selected adapter cables, and from the selected adapter cables to the user's cellular phones, the computer may exchange electronic data with each of the cellular phones. As such, the cable method offers its users the flexibility to communicably couple a computer system to a plurality of cellular phones with different interface connectors and originating from different manufacturers. This allows the user to communicably couple more than one phone to a computer system, such as when the user upgrades to a new phone with a different interface connector or within a family where some members of the family use a different cellular phone with a different interface connector.

The data transfer hub permits simultaneous connectivity of more than one cell phone to a computer system. Where the computer system can be configured to upload and download data to each of the cell phones, multiple applications are possible. For example, data backup, data transfer from one cell phone to another, data format, etc.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

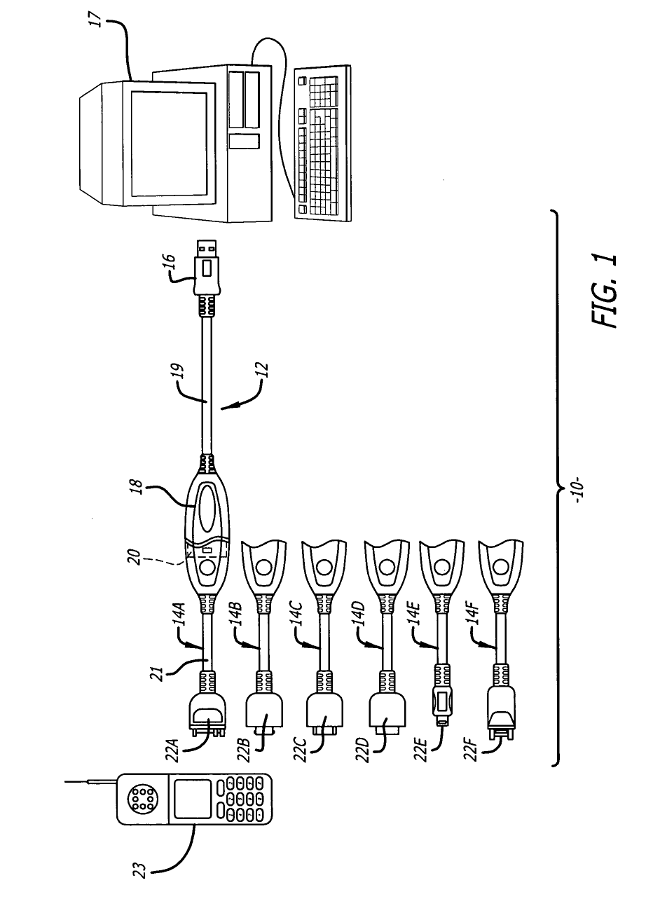

FIG. 1 illustrates a cable system 10 including a base cable 12 and a plurality of adapter cables 14A through 14F configured to interface data between a personal computer and a plurality of cellular phones. The base cable 12 has a base connector 16 adapted to couple to a first electronic device 17. The first electronic device 17 may be a variety of electronic devices where information may be stored electronically such as a computer system and PDA. The base cable 12 also has a base interface end 18 adapted to communicably couple with the plurality of adapter cables 14A through 14F. The base cable 12 includes a cable 19 between the base connector 16 and the base interface end 18 to transmit data between the two connectors 16 and 18.

Each of the plurality of adapter cables 14A through 14F has an adapter interface end 20 and a corresponding adapter connector 22. A cable 21 is provided between the adapter interface end 20 and the adapter connector 22. The adapter interface end 20 is configured to communicably couple with the base interface end 18. Each of the plurality of adapter cables 14 also has a corresponding adapter connector 22 that is configured to communicably couple to a particular cellular phone 23. For instance, the adapter connector 22A may be adapted to communicably couple to a LG™ phone; the adapter connector 22B may be adapted to communicably couple to a Nokia™ phone; the adapter connector 22C may be adapted to communicably couple to an Ericsson™ phone; the adapter connector 22D may be adapted to communicably couple to a Samsung™ phone; the adapter connector 22E may be adapted to communicably couple to a Motorola™ phone; and the adapter connector 22F may be adapted to communicably couple to a Sony™ phone. As such, with the cable system 10, one base cable 12 may be provided with a plurality of adapter cables so that a computer system may share data with a variety of different types of cellular phones with different data interface connectors. That is, the user may select a particular adapter cable corresponding to the type of cellular phone the user is using then couple the base interface end 18 to the adapter interface end 20 to exchange data between the first electronic device and the desired cellular phone.

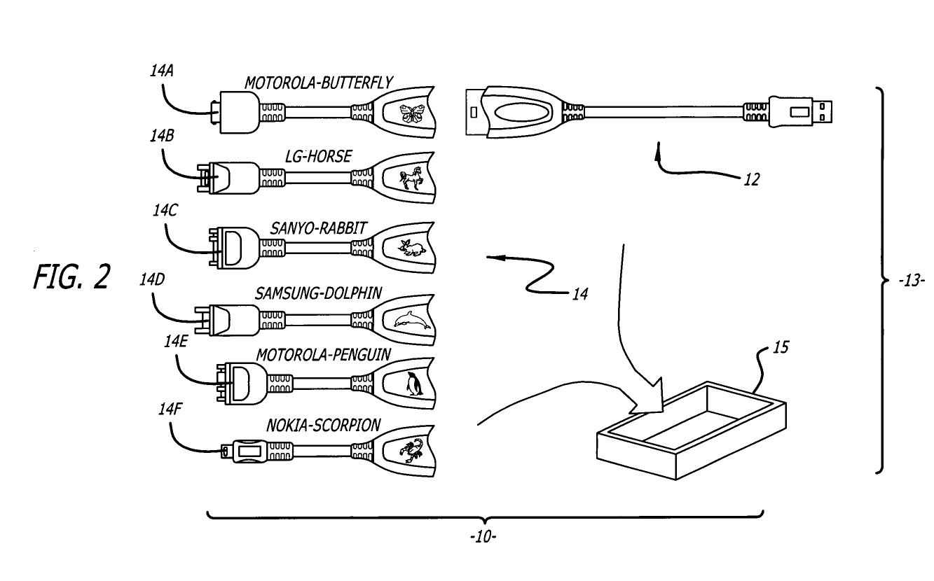

FIG. 2 illustrates each of the plurality of adapter cables 14A through 14F including a symbol on the adapter interface end 20, each of the symbols corresponding to a particular cellular phone. The symbol on the adapter interface end may correspond to a particular cellular phone manufacturer.. For instance, a butterfly symbol may correspond to a certain types of Motorola cellular phones; a horse symbol may correspond to LG cellular phones; a rabbit symbol may correspond to Sanyo cellular phones; a dolphin symbol may correspond to Samsung cellular phones; a penguin symbol may correspond to a particular type of Motorola cellular phones; and a scorpion symbol may correspond to Nokia cellular phones.

In one embodiment, a chart may be provided with a list of the symbols and different types of cellular phones that may be used corresponding to each of the symbols. This way, a user may review the chart and find a symbol that corresponds to the cellular phone the user is using. Based on the symbol, the user may select the right adapter cable to communicably couple with the base cable 12 to exchange data between the computer system and the user's cellular phone. In this regard, a cable kit 13 may be provided in a container 15 with a base cable 12, a plurality of adapter cables 14A through 14F, and a table with a list of symbols to indicate to a user the symbol that corresponds to a particular cellular phone the user is using.

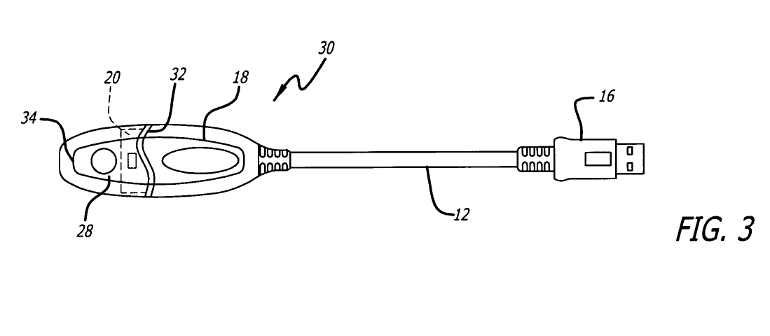

FIG. 3 illustrates a cable system 30 including a base cable 12, as discussed above, adapted to communicably couple with an IrDa (infrared) attachment 28. The base connector 16 of the base cable 12 is adapted to communicably couple to the USB port of the computer system 17. The IrDa attachment 28 has an interface side 32 and a transceiver 34. The interface side 32 of the attachment 28 is adapted to communicably couple with the base interface end 18 of the base cable 12. The transceiver 34 is capable of transmitting the data provided through the base cable 12 wirelessly to a second electronic device such as a cellular phone. That is, the IrDa attachment 28 sends the data from the computer system 17 wirelessly through infrared signals. A second electronic device, such as a cellular phone, with an infrared port may then receive the infrared signals to exchange the data wirelessly with the computer system.

Some computer systems are not equipped with a port such as an infrared port and/or Bluetooth port to allow the computer systems to communicate wirelessly with other electronic devices. In such instances, the cable system 30 may be used to wirelessly couple a computer system, without a wireless communication port, with a variety of cellular phones. The base connector 16 of the base cable 12 may be connected to the USB port of the computer system. On the opposite end, the interface side 32 of the attachment 28 is coupled to the base interface end 18 of the base cable 12. With such communication links, the base cable 12 is able to provide the data from the USB port of the computer system to the attachment 28 to transmit the data wirelessly to a second electronic device such as a cellular phone that has an infrared port or a Bluetooth port to receive the data provided through the USB port of the computer system. Conversely, the attachment 28 may receive data transmitted from the infrared port or Bluetooth port of the cellular phone 17. This way, a computer system that does not have a port to receive wireless data may exchange data wirelessly with a cellular phone.

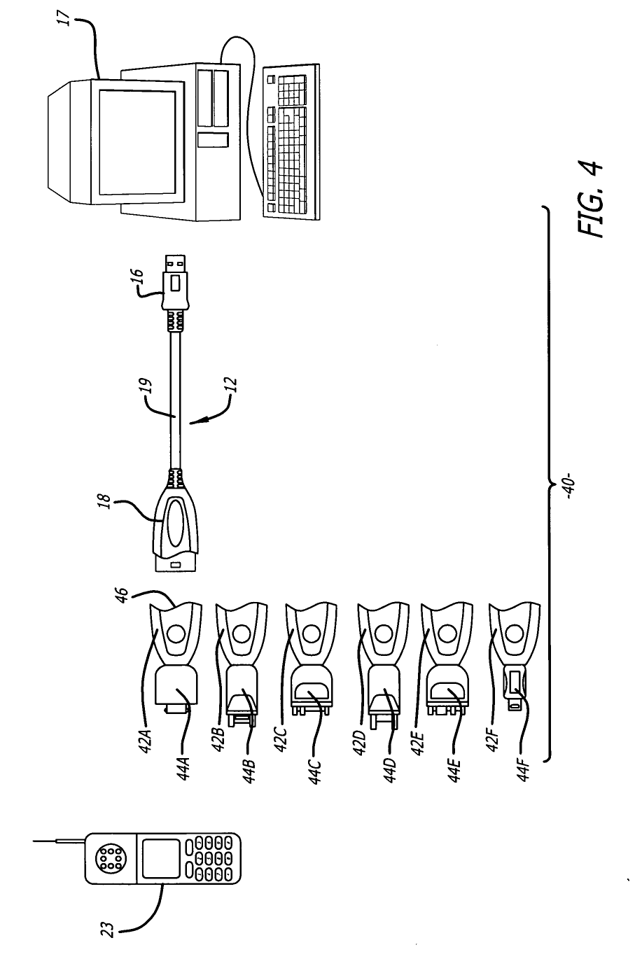

FIG. 4 illustrates a cable system including a base cable and an alternative plurality of adapters. Each of the adapters 42 has an interface end 46 that is substantially similar to the adapter interface end 20, as discussed above, to allow the interface end 46 to communicably couple to the base interface end 18. Each of the plurality of the adapters 42A through 42F has a connecting end 44A through 44F, respectively. Each connecting end is configured to communicably couple with a particular cellular phone. Note that the adapters 42A-42F do not have a cable between the connecting end 44 and the interface end 46. The base cable 12, however, is provided with the cable 19 to allow the base cable 12 to extend between the computer system 17 and the cellular phone 23. One of the adapters 42A through 42F may be used to communicably couple the base cable 12 with a particular cellular phone. For example, the connecting end 44A may communicably couple to an LG™ phone; the connecting end 44B may communicably couple to a Nokia™ phone; the connecting end 44C may communicably couple to an Ericsson™ phone; the connecting end 44D may communicably couple to a Samsung™ phone; the connecting end 44E may communicably couple to a Motorola™ phone; and the connecting end 44F may communicably couple to a Sony™ phone. To exchange data between the computer system 17 and a Nokia™ phone, for example, a user may communicably couple the connecting end 44B of the adapter 42B to the Nokia™ phone. The base connector 16 of the base cable 12 is then communicably coupled to the computer system 12 and the base interface end 18 is communicably coupled to the interface end 46 of the adapter 42. With the cable system 40 communicably coupling the computer system 17 to the Nokia™ phone, data may be exchanged between the two electronic devices 17 and 23.

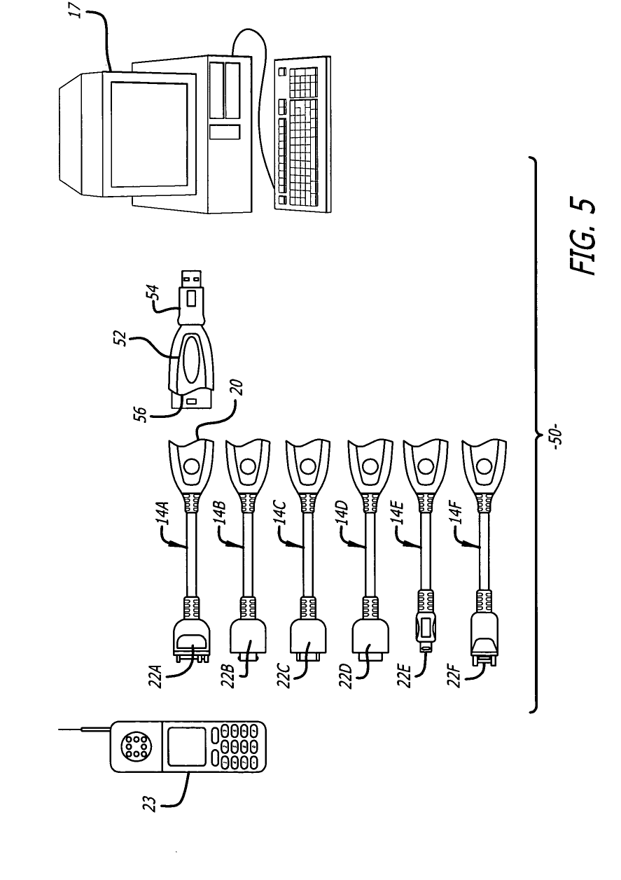

FIG. 5 illustrates a cable system 50 including a base 52 and a plurality of adapter cables 14A through 14F. The plurality of adapter cables 14A through 14F is substantially similar to the adapter cables discussed above in reference to FIG. 1. The base 52 has a base connector 54 and a base interface end 56 that are substantially similar to the base connector 16 and the base interface end 18, respectively. The base 52, however, may not include a cable between the two connectors 16 and 18. As discussed above with regard to FIG. 1, the base connector 16 is adapted to communicable couple to the computer system 17 and the base interface end 18 is configured to communicably couple to the adapter interface end 20 of the adapter cable. Accordingly, the cable system 50 may be used to communicably couple a computer system with a plurality of cellular phones to allow the computer system to exchange data with any one of the plurality of cellular phones.

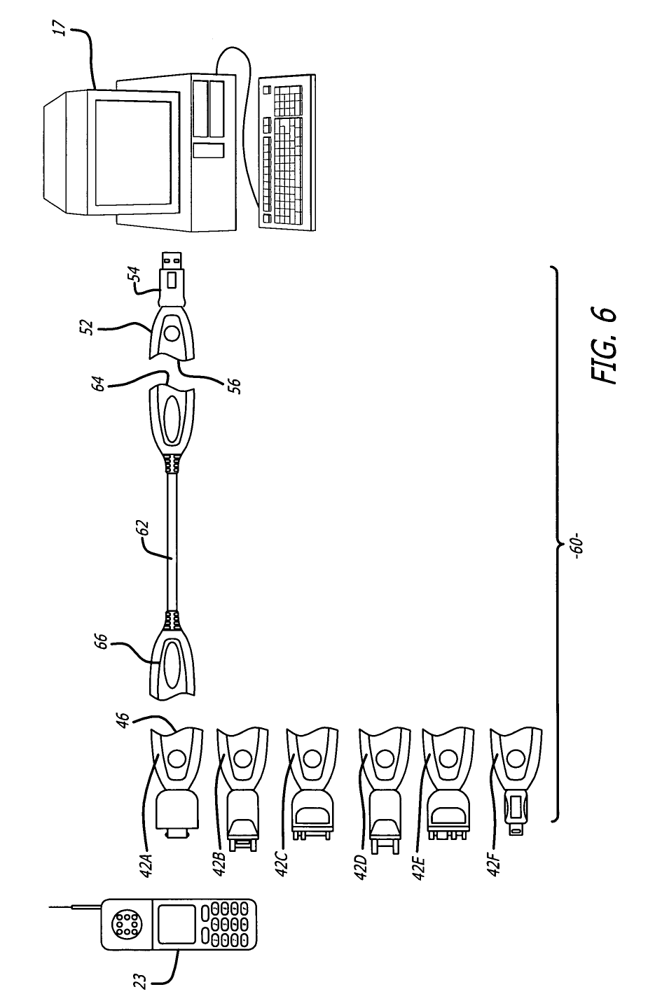

FIG. 6 illustrates a cable system 60 including an intermediate cable 62 configured to communicably couple in between a base adapter 52 and a plurality of adapters 42A through 42F. The plurality of adapters 42A through 42F and the base adapter 52 are substantially similar to the ones described in FIGS. 4 and 5 above, respectively. The intermediate cable 62 has a first interface end 64 and a second interface end 66 configured to communicably couple to the base adapter 52 and the plurality of adapters 42A through 42F, respectively. A user may select one adapter from the plurality of adapters 42A through 42F that is configured to communicably couple with the user's cellular phone. The second end 66 of the intermediate cable 62 may be coupled to the interface end 46 of the selected adapter and the first end 64 of the intermediate cable 62 may be coupled to the base interface end 56 of the base adapter 52. With the cable system 60 assembled, the base connector 54 may be communicably coupled to the computer system 17 to allow the computer system 17 to exchange data with the cellular phone. In addition, the base connector end 54 may be adapted to communicably couple to a variety of first electronic devices other than the computer system 17, such as PDA and IPod™.

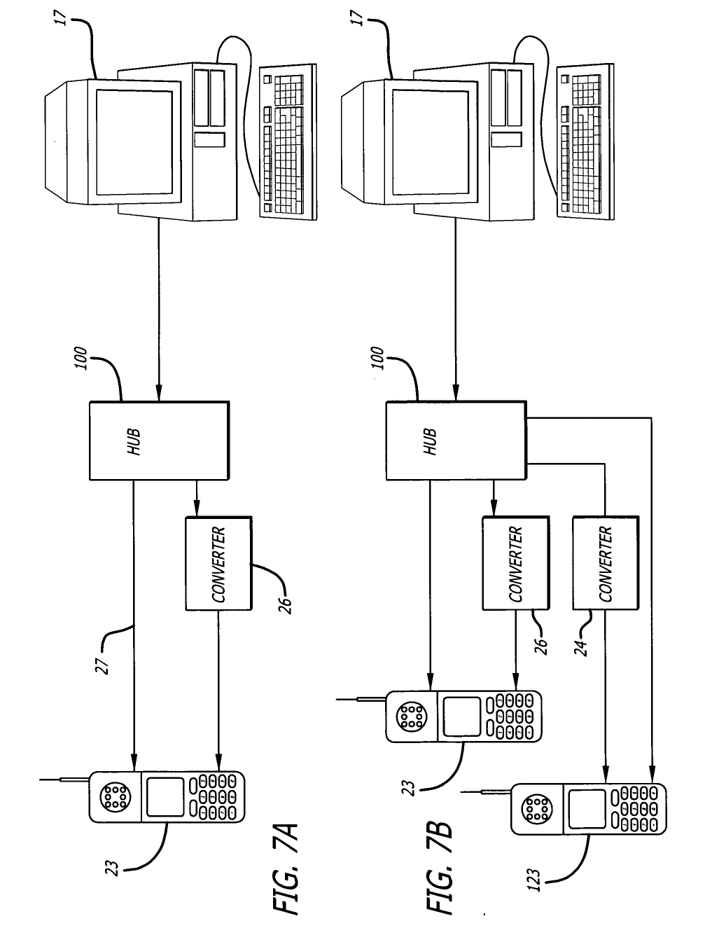

FIG. 7A illustrates a data transfer hub 100 and a converter 26 to interface data between a personal computer and a plurality of cellular phones. In one embodiment, the data transfer hub 100 allows the cellular phones not equipped with Code-Division Multiple Access (CDMA) chips and USB output to communicate with a computer system. Most, if not all, computer systems are provided with a USB port for exchanging data which permits cellular phones with a CDMA chip and a USB port to communicate directly with a computer system. Many cellular phones, however, are not provided with a CDMA chip, so that direct USB serial communication between the cellular phones without a CDMA and a computer system is not possible. To accommodate cellular phones with and without the CDMA chip, the universal cable system 10 may be coupled with the data transfer hub 100 and the converter 26. If the cellular phone is able to directly receive the USB output from a computer system, the data transfer hub 100 provides a direct interface between the computer system and the cellular phone. On the other hand, if the cellular phone is unable to directly receive the USB output, the data transfer hub 100 sends the signal from the computer system to the serial converter 26, which sends a serial signal to the cellular phone. In one approach, the circuitry for the data transfer hub 100 and the converter 26 may be provided within the base interface 18 so that the same circuitry can be used with the variety of adapter cables to minimize the cost of the universal cable system 10. In another approach, the circuitry for the data transfer hub 100 and the converter 26 can be included in a separate housing.

FIG. 7B illustrates a data transfer hub 100 and two converters that allow two cell phones to interface with a personal computer 17. The data transfer hub 100 can accommodate more than one converter, so that multiple cell phones can be coupled. For example, an additional converter 24 can be provided so that a second cell phone 123 can communicate with computer system 17 if the second cell phone 123 does not have a CDMA chip. Again, if the cellular phone 123 is able to directly receive the USB output from a computer system, the data transfer hub 100 provides a direct interface between the computer system 17 and the cellular phone 123. Such direct interface, as explained above, can be an adapter cable that couples to the cell phone 23. On the other hand, if the cellular phone 123 is unable to directly receive the USB output, the data transfer hub 100 sends the signal from the computer system 17 to the serial converter 24, which sends a serial signal to the cellular phone 123. In one embodiment, the converters 26 and 24 connect to the data transfer hub 100 through a USB connection.

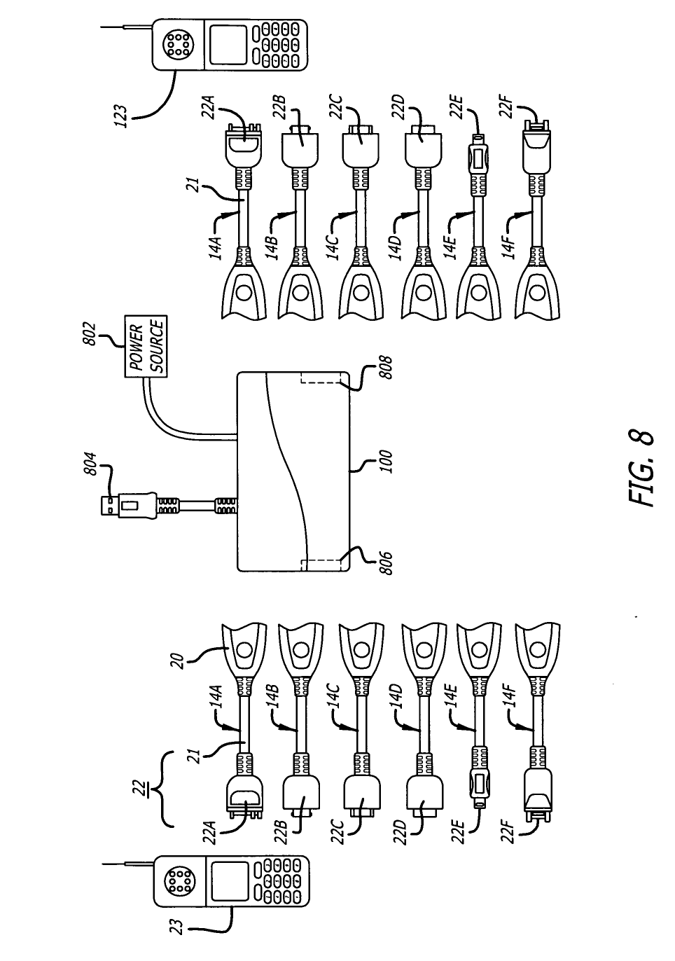

FIG. 8 illustrates a cable system adaptable to a data transfer hub to transfer data from a first cellular phone to a second cellular phone. Each of the plurality of adapter cables 14A through 14F has an adapter interface end 20 and a corresponding adapter connector 22. A cable 21 is provided to communicatively join the adapter interface end 20 and the adapter connector 22. The adapter interface end 20 of each cable is configured to communicably couple with the universal port 806 and 808. Each of the plurality of adapter cables 14 also has a corresponding adapter connector 22 that is configured to communicably couple to a particular cellular phone 23. As described above, each adapter connector 22 may be adapted to communicably couple to a cell phone model of a particular manufacturer.

In the cable system 10, the data transfer hub 100 can be provided instead of the base cable 12. As described above, the adapter cables 14 connect to a computer system through a base cable 12. Because the data transfer hub 100 includes the functionality of the base cable 12, a cellular phone 23 can communicate with a computer system 17 using the base cable 12. The data transfer hub 100 includes an input for a USB connector 804 that couples with a computer system. The data transfer hub 100 is connected to a power source 802. Even though the data transfer hub 100 can receive power through the USB connector 804, the power source 802 allows for an independent and direct source of power.

In one embodiment, the data transfer hub 100 can be provided with two universal connectors 806 and 808. Thus, through the universal connectors 806 and 808, the data transfer hub 100 can connect with at least two adapter cables 14. Thus, a data transfer hub 100 may transfer data back and forth with a variety of different types of cellular phones with different data interface connectors. When the user selects the adapter cable that corresponds to the type of cellular phone that the user uses, the user can plug in the adapter cable to the phone, and then one of the universal connectors 806 or 808 of the data transfer hub 100.

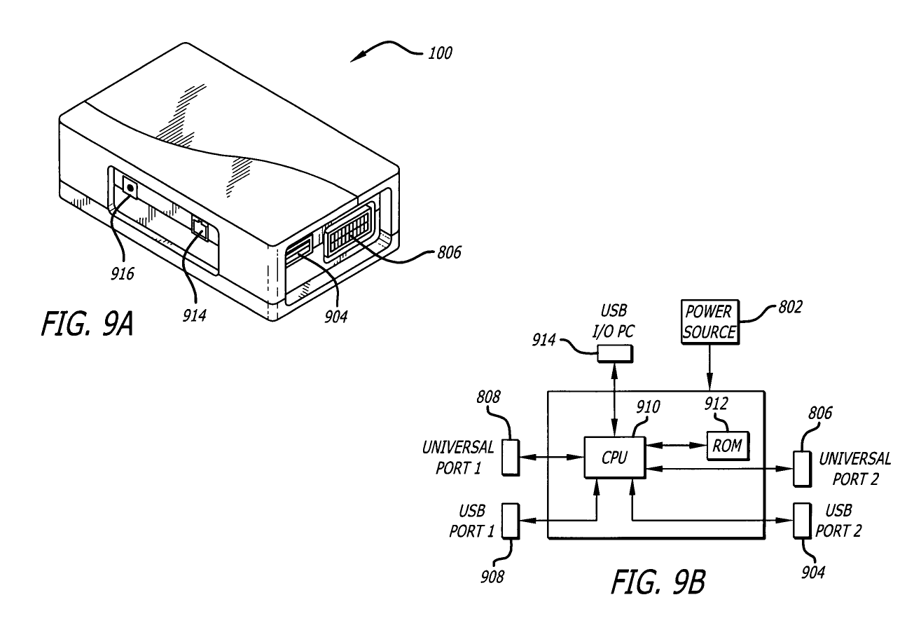

FIG. 9A illustrates an external view of the data transfer hub 100. In one embodiment, the data transfer hub 100 includes the universal port 806 on one side having a connection socket that mates with a corresponding plug in the adapter interface end 20 of the adapter cable utilized. As mentioned before, any of the adapter cables 14 can be connected to the data transfer hub 100 through the universal port 806 or the universal port 808. The hardware configuration of the plug in the adapter interface 20 of each of the adapter cables 14 can be the same such that any adapter cable 14, and consequently, any cellular phone, can be connected to the data transfer hub 100.

In another embodiment, a USB port 904 can be included so that cell phones having USB connectivity can directly connect to the data transfer hub 100 without the need to utilize an adapter cable 14. A USB port 914 can be included in the data transfer hub 100 for communicating with computer system 17. Other communication protocols can be used to communicate with computer system 17.

FIG. 9B illustrates a component diagram of a data transfer hub 100. A central processing unit 910 can be included in the data transfer hub 100 to communicate with devices connected to any of the ports provided. Universal port 806, universal port 808, USB port 908, and USB port 904 are configured to be either a source or a target ports.

In one embodiment, universal port 808 and universal port 806 are configured to be a source and a target respectively, such that data received at universal port 808 is ultimately transmitted to universal port 806 and to the device connected thereto.

A memory module 912 can be operably connected to the central processing unit 910 in order to provide stored configuration data, data types used by cellular phones manufacturers, security data, etc. As such, when data from a device connected to universal port 808 is received by the central processing unit 910, the memory module 921 can be accessed to retrieve interpretation keys or data in order to convert the data received to a standard data type.

In one embodiment, the central processing unit 910 relays the information to the computer system 17 in a standard format. Thus, for the computer system 17 it is transparent the manufacturer or type of the cellular phone connected to the data transfer hub 100. For example, as soon as a cellular phone is connected to the universal port 806, the central processing unit 910 computes the make and model of the cellular phone connected by looking up pre-stored data on the memory module 912. Once the central processing unit 910 establishes the type of cell phone connected, it is assumed that any data received on universal port 806 has the data type characteristic of the make and module of the phone. In another approach, every time the data is received at port 806 the data is checked for the type of make and module and then translated.

Likewise, the computer system 17 can send data signals to the data transfer hub 100 such that when the central processing unit 910 receives the data, the central processing unit 910 can encode the data received into the format required by the target cellular phone.

In another embodiment, the data is not converted to a uniform format, but the computer system 17 upon receiving data, and before transmitting data, converts to the correct format.

In another embodiment, the central processing unit 910 upon receiving a signal that the target device is connected, the central processing unit 910 identifies the type of device (e.g. cell phone manufacturer) by querying memory module 912, and sets the encoding and decoding to the data format of the target device.

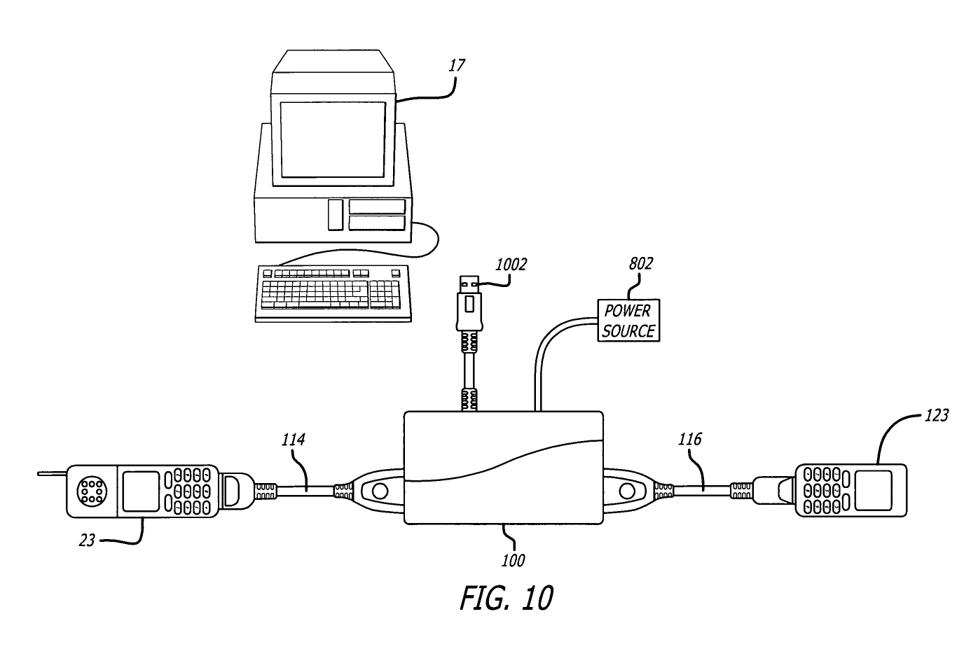

FIG. 10 illustrates the data transfer hub 100 connectivity to a computer system and to at least two cellular phones. In one example, the universal port 806 can be configured to be the source port and marked to that effect. Likewise, the universal port 808 can be configured to be the target port. A user wishing to make a data transfer from one cell phone to another can simply connect cell phone 23 to universal port 806, the source port, utilizing an appropriate adapter cable 114. The adapter cable 114 is connected to the data transfer hub 100 at the universal port 806. Next, the target phone 123 can be connected to universal port 808 utilizing adapter cable 116. The adapter cable 116 being of course compatible with the cell phone 123. Once both cell phones 23 and 123 are connected to he data transfer hub 100, the data transfer hub 100 can be connected to the computer system 117 by utilizing USB connector 1002 and to universal port 808. The user of the data transfer hub 100 can then either upload and download data to either cell phone by using a computer application configured to communicate with the USB port at the computer (not shown) and with the devices connected to he USB port.

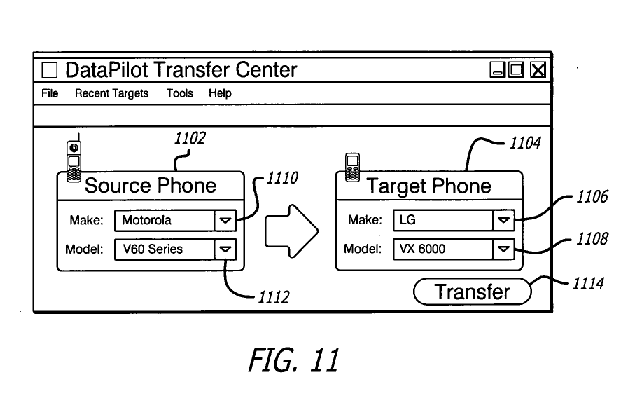

FIG. 11 illustrates a screenshot of a computer application showing a data transfer operation. In one embodiment, an application installed in the computer system 17 can be provided for the user to transfer data from one cellular phone to another. The application is configured to communicate data to the data communication hub 100 through a USB port in the computer system 17.

In one embodiment, the user application can display an interface window with two panes: a source phone pane 1102 and a target phone pane 1104. The source phone pane 1102 includes a mechanism to select the type of the source phone. In one approach, the pane 1102 can include a make drop down menu 1110 and a model drop down menu 1112. The make drop down menu 1110 includes options for different device manufacturers such as Nokia™, Ericsson™, Samsung™, Motorola™, Sony™, etc. Once the make drop down menu 1110 selection is made, the model drop down menu 1112 updates automatically to display the different models available for the selected manufacturer. In another approach, the make drop down menu 1110 is defaulted to “Auto” which indicates that the program will automatically detect which kind of cell phone or wireless device it is. In the target pane, a make drop down menu 1106 and a model drop down menu 1108 can also be included and can function in similar fashion as the make drop down menu 1110 and the model drop down menu 1112. The make drop down menu 1106 can also be defaulted to “Auto” for auto detection of the target cell phone type. Finally, when the user clicks on a transfer button 1114 the data from the source phone is transferred to the target phone.

In one embodiment, the data transferred from the source phone to the target phone is an address book. For example, a user that buys a new cell phone can keep the contact information by transferring from the old phone to the new phone. The application software is able to request particular data from the source phone because the application software includes a database of communication and data protocols used by the particular make and model of the source phone. As such, the application software can request contact information using for example, a name-address-number format. The application software parses the contact information received according to the known parameters of the communication and data protocols of the source phone.

Next, the application software determines the communication and data protocols used for the target phone. If, for example, the target phone has a name-number-address format for storing contact information, then the application software will translate the source phone format of name-address-number to the target phone format of name-address-number.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. For instance, various combinations of wireless devices such as PDAs, Balckberry, iPods, can also be connected to the data transfer hub. Accordingly, it is intended that the art disclosed shall be limited only to the extent required by the appended claims and the rules and principles of applicable law.

I claim:

1. A method of transferring data between a source wireless device having a first connector configuration and a target wireless device having a second connector configuration different from the first connector configuration, comprising:
providing a data transfer hub having universal connectors, the universal connectors being connectable to a plurality of adapter cables;
connecting the source device to a first universal connector on the data transfer hub via a first adapter cable of the plurality of adapter cables;
connecting the target device to a second universal connector on the data transfer hub via a second adapter cable of the plurality of adapter cables;
connecting the data transfer hub to a computer system configured to receive and transmit data between the source wireless device and the target wireless device through the data transfer hub; and
transmitting data between the source device and the target device.

2. The method of claim 1, wherein the source wireless device and the source target wireless device are cell phones.

3. The method of claim 1, wherein the source wireless device and the source target wireless device are personal data assistants.

4. The method of claim 1, wherein the source wireless device is manufactured by a different manufacturer than the target wireless device.

5. The method of claim 1, wherein the computer system is configured to convert data from the source wireless device into a data format that can be recognized by the target wireless device.

6. The method of claim 1, wherein the computer system is configured to convert data from the source wireless device into a data format that can be recognized by the target wireless device.

7. The method of claim 1, wherein the computer system is configured with a single computer application that converts data from the source wireless device into a data format that can be recognized by the target wireless device.

8. The method of claim 1, wherein the data transfer hub and the computer system are connected via a universal serial bus connection.

9. A method of interfacing data between a computer system and a plurality of portable devices, comprising:
providing a data transfer hub and a plurality of adapter cables, wherein the a data transfer hub has a computer system connector and at least one universal port, and wherein each of the plurality of adapter cables has an adapter connector end and an adapter interface end;
configuring the data transfer hub to communicably couple with a computer system;
configuring adapter connector end of each of the plurality of the adapter cables to communicably couple with a corresponding data communication connector provided in the plurality of portable devices; and
configuring the adapter interface end of each of the plurality of the adapter cables to communicably couple with the at least one universal port of the data transfer hub to allow the computer system to communicate with any one of the plurality of portable devices.

10. The method of claim 9, wherein the plurality of the portable devices are wireless devices from different manufacturers.

11. The method of claim 9, including converting electronic signals from the computer system to converted signals, if needed, to allow any one of the plurality of portable devices to communicate with the computer system.

12. The method of claim 9, wherein the computer system device is configured to recognize the communication signals of each of the plurality of portable devices based on the adapter cable portion being used.

13. The method of claim 9, further comprising marking the plurality of adapter cables with a different symbol to associate each of the plurality of adapter cables with the corresponding data communication connector provided in the plurality of portable devices.

14. The method of claim 9, further comprising configuring a wireless attachment to communicably couple with the data transfer hub to transmit wireless signals from the data transfer hub to at least one of the plurality of portable devices.

15. A system to interface data between a computer system and a plurality of cell phones, comprising:
a data transfer hub having a computer system connector and at least one universal port;
a plurality of adapter cables, wherein each of the plurality of adapter cables has an adapter connector end and an adapter interface end;
a computer system communicably coupled to the data transfer hub;
wherein the adapter connector end of each of the plurality of the adapter cables is configured to communicably couple with a corresponding data communication connector provided in the plurality of portable devices; and
wherein the adapter interface end of each of the plurality of the adapter cables is configured to communicably couple with the at least one universal port of the data transfer hub to allow the computer system to communicate with any one of the plurality of portable devices.
